(19) United States
(12) Patent Application Publication
(10) Pub. No.: US 2018/0294513 A1
(43) Pub. Date: Oct. 11, 2018

(54) PROTECTIVE FILM FOR LITHIUM ELECTRODE, AND LITHIUM ELECTRODE AND LITHIUM SECONDARY BATTERY COMPRISING SAME

(71) Applicant: LG CHEM, LTD., Seoul (KR)

(72) Inventors: Euiyong HWANG, Daejeon (KR); Jihye YANG, Daejeon (KR); Dongwook KOH, Daejeon (KR); Jangbae KIM, Daejeon (KR)

(73) Assignee: LG CHEM, LTD., Seoul (KR)

(21) Appl. No.: 15/766,106

(22) PCT Filed: Apr. 4, 2017
(86) PCT No.: PCT/KR2017/003672

§ 371 Date: Apr. 5, 2018

(30) Foreign Application Priority Data
Apr. 14, 2016 (KR) 10-2016-0045319

(51) Int. Cl. H01M 10/0525; H01M 10/44; H01M 4/583; H01M 4/134; H01M 4/66; H01M 2/16

(52) U.S. Cl. CPC H01M 10/0525; H01M 10/44; H01M 4/583; H01M 2004/027; H01M 4/661; H01M 2/1626; H01M 4/134

(57) ABSTRACT

The present invention relates to a passivation layer for a lithium electrode, and a lithium electrode and a lithium secondary battery including the same, and in particular, to a lithium electrode capable of enhancing battery performance by securing a sufficient level of strength to suppress lithium dendrite growth through forming a passivation layer in an electrode including lithium, and through forming the passivation layer in a fibrous network structure, and a lithium secondary battery including the same.

### TECHNICAL FIELD

This application claims priority to and the benefits of Korean Patent Application No. 10-2016-0045319, filed with the Korean Intellectual Property Office on Apr. 14, 2016, the entire contents of which are incorporated herein by reference.

The present invention relates to a passivation layer for a lithium electrode capable of enhancing battery performance even at a high rate by including a high strength passivation layer, and a lithium electrode and a secondary battery including the same.

### BACKGROUND ART

With rapid development of electronics, communications and computer industries, application fields of energy storage technologies have expanded to camcorders, mobile phones, laptops, PCs, and furthermore, to electric vehicles. Accordingly, development of high performance secondary batteries that are light, usable for a long period of time and highly reliable has been in progress.

As batteries satisfying such requirements, lithium secondary batteries have received attention.

A lithium secondary battery has a structure of laminating or winding an electrode assembly including a positive electrode, a negative electrode, and a separator provided between the positive electrode and the negative electrode, and is formed by embedding this electrode assembly in a battery case, and injecting a non-aqueous liquid electrolyte thereinto. The lithium secondary battery produces electric energy through an oxidation and reduction reaction when lithium ions are intercalated/deintercalated in the positive electrode and the negative electrode.

In a common lithium secondary battery, a negative electrode uses lithium metal, carbon and the like as an active material, and a positive electrode uses lithium oxide, transition metal oxides, metal chalcogen compounds, conductive polymers and the like as an active material.

Among these, a lithium secondary battery using lithium metal as a negative electrode mostly attaches lithium foil on a copper current collector, or uses a lithium metal sheet itself as an electrode. Lithium metal has low potential and high capacity, and has received much attention as a high capacity negative electrode material.

When using lithium metal as a negative electrode, electron density non-uniformization may occur on the lithium metal surface during battery operation due to various reasons. As a result, a branch-shaped lithium dendrite is produced on the electrode surface causing formation and growth of projections on the electrode surface making the electrode surface very rough. Such lithium dendrite causes, together with battery performance decline, separator damages and battery short circuits in severe cases. As a result, a temperature in the battery increases causing risks of battery explosion and fire.

In addition, lithium used in an electrode, particularly, a lithium electrode, has high reactivity with a liquid electrolyte, and when a liquid electrolyte component has brought into contact with lithium metal, a film referred to as a passivation layer is formed through a spontaneous reaction. The passivation layer formed on the lithium surface during charge and discharge repeatedly goes through destruction and formation, and when repeatedly carrying out battery charge and discharge, a problem of increasing a passivation layer component and depleting a liquid electrolyte in the lithium negative electrode occurs. In addition, some of reduced materials in the liquid electrolyte cause side reactions with lithium metal advancing lithium consumption. As a result, battery life time is reduced.

In view of the above, diversified studies have been progressed in order to stabilize lithium metal, and as a part of such studies, a method of forming a passivation layer at a position adjoining an electrode was proposed.

Korean Patent No. 10-0425585 discloses a technology forming a crosslinked polymer passivation layer using a diacryl-based monomer represented by CH₂═CH—CO₂—(CH₂)₈—CO₂—CH═CH₂ on a lithium electrode surface, and describes that battery life time may increase by suppressing lithium dendrite growth and stabilizing the lithium electrode with the crosslinked polymer passivation layer. However, the crosslinked polymer passivation layer causes a new problem of swelling or damage when adjoining a liquid electrolyte.

In addition, Korean Patent Application Laid-Open Publication No. 2014-83181 discloses that, while disclosing a lithium negative electrode having a passivation layer including a polyvinylene carbonate-based polymer and inorganic particles such as SiO₂, Al₂O₃ or TiO₂ having a diameter of 1 nm to 10 μm formed on a lithium metal surface, lithium metal may be stabilized and interfacial resistance between the lithium electrode-electrolyte may be reduced. However, the inorganic particles in the passivation layer are globular particles and cause a problem of lithium dendrite growing along the globular particle interface, and risks of battery short circuit are still present.

As described above, containing a crosslinked polymer and/or inorganic particles in a passivation layer has presented somewhat excellent performance at a low rate and lithium ion migration of a small amount, however, the effects have not been able to sufficiently secure at a high rate.

### PRIOR ART DOCUMENTS

Korean Patent No. 10-0425585, Lithium polymer secondary battery having crosslinked polymer protective thin film and method for manufacturing the same

Korean Patent Application Laid-Open Publication No. 2014-83181, Lithium electrode and lithium metal battery manufactured using the same

### DISCLOSURE

### Technical Problem

In view of the above, the inventors of the present invention have developed a lithium secondary battery forming a passivation layer so as to effectively prevent lithium dendrite formation and to uniformly transfer lithium ions to a lithium electrode, and specifying constituents of the passivation layer so as to prevent an overvoltage or short circuit during charge and discharge, identified that battery performance is enhanced when measuring battery properties using the same, and have completed the present invention.

Accordingly, an aspect of the present invention provides a passivation layer for a lithium electrode provided with a passivation material capable of suppressing growth of lithium dendrite formed on an electrode lithium and capable of uniformly transferring lithium ions.

Another aspect of the present invention provides a lithium electrode having the passivation layer disposed on at least one side surface.

Another aspect of the present invention provides a lithium secondary battery having enhanced battery performance even at a high rate by including the lithium electrode.

### Technical Solution

According to an aspect of the present invention, there is provided a passivation layer for a lithium electrode having a fibrous network structure including a cellulose-based fibrous filler.

According to another aspect of the present invention, there is provided a lithium electrode including a lithium metal layer; and a passivation layer formed on the lithium metal layer and having a fibrous network structure formed with a fibrous filler.

Herein, the fibrous filler further includes one type selected from the group consisting of organic fillers, inorganic fillers and combinations thereof.

The passivation layer further includes one type selected from the group consisting of an ion conductive polymer, a lithium salt, inorganic oxide particles and a mixture thereof.

The ion conductive polymer has a matrix structure by being introduced to the passivation layer in a crosslinked form.

In addition, the inorganic oxide particles are introduced in a form of being inserted between the fibrous fillers.

According to another aspect of the present invention, there is provided a lithium secondary battery including a positive electrode, a negative electrode, a separator provided therebetween and an electrolyte, with the passivation layer disposed between the negative electrode and the separator.

### Advantageous Effects

A passivation layer according to the present invention has a fibrous network form and thereby exhibits high strength, and therefore, physically suppresses growth of lithium dendrite on an electrode surface resultantly preventing battery performance decline and securing stability during battery operation.

The passivation layer can effectively transfer lithium ions to an electrode, particularly lithium metal, without the passivation layer itself functioning as a resistive layer due to its excellent ion conductivity, and therefore, an overvoltage is not applied during charge and discharge and the passivation layer can also be used during rapid charge and discharge.

Accordingly, a lithium electrode provided with the passivation layer according to the present invention can be favorably used as a negative electrode of a lithium secondary battery, and this can be used in various devices, for example, from most small electronic devices to high capacity energy storage systems, and the like using lithium metal as a negative electrode.

### DESCRIPTION OF DRAWINGS

FIG. 1 is a sectional diagram of a lithium electrode according to the present invention.

FIG. 2 is a sectional diagram showing an example of a lithium electrode according to the present invention.

FIG. 3 is a mimetic diagram of a passivation layer according to a first embodiment of the present invention.

FIG. 4 is (a) a mimetic diagram illustrating lithium dendrite growth in a fibrous filler in a lithium electrode according to the present invention, and (b) a mimetic diagram illustrating lithium dendrite growth in an existing inorganic filler.

FIG. 5 is (a) a mimetic diagram illustrating a constitution of a passivation layer, and (b) a sectional diagram of a lithium electrode including the same according to a second embodiment of the present invention.

FIG. 6 is (a) a mimetic diagram illustrating a constitution of a passivation layer, and (b) a sectional diagram of a lithium electrode including the same according to a third embodiment of the present invention.

FIG. 7 is (a) a mimetic diagram illustrating a constitution of a passivation layer, and (b) a sectional diagram of a lithium electrode including the same according to a fourth embodiment of the present invention.

FIG. 8 shows images of lithium electrodes prepared in (a) Example 1, (b) Example 2, (c) Example 3, (d) Comparative Example 1 (bare Li) and (e) Comparative Example 2 after performing charge and discharge.

FIG. 9 shows scanning electron microscope images of lithium electrodes in batteries of (a) Example 1 and (b) Comparative Example 1 (bare Li).

FIG. 10 is a graph comparing an overvoltage during 10 cycles of lithium secondary batteries manufactured in Example 1, Example 2 and Comparative Example 1 (bare Li).

FIG. 11 is a graph showing a result of durability experiment on a lithium secondary battery manufactured in Example 3.

### BEST MODE

Hereinafter, the present invention will be described in more detail.

Passivation Layer and Lithium Electrode

A lithium electrode used as a negative electrode of a lithium secondary battery is formed with lithium metal and forms a passivation layer on a surface of the lithium metal, and therefore, lithium dendrite is formed and/or grown on the surface inhibiting battery property (that is, life time and efficiency) decline in the lithium secondary battery. However, lithium dendrite growth has not been able to be sufficiently suppressed with just an existing passivation layer including a crosslinked polymer and inorganic particles due to its low strength. In view of the above, a fibrous filler is selected as a passivation layer composition in the present invention instead of simple crosslinking or inorganic particles, and a sufficient level of strength to suppress lithium dendrite growth is secured by forming the passivation layer to have a dense fibrous network structure using the same. In addition, the passivation layer has excellent wettability for a liquid electrolyte and thereby effectively transfers lithium ions to a lithium metal layer side, and the battery may be stably operated even at a high current.

In a lithium electrode according to the present invention, a passivation layer is disposed on one side surface or both side surfaces of a lithium metal layer. Hereinafter, detailed descriptions will be provided with reference to accompanying drawings.

FIG. 1 is a sectional diagram of a lithium electrode according to one embodiment of the present invention.

When referring to FIG. 1, the lithium electrode (10) has a structure in which a passivation layer (3) is laminated on a lithium metal layer (1). Such a structure forms the passivation layer (3) on only one side of the lithium metal layer (1), and this is for convenience of description and the present invention is not limited to such a structure.

The lithium metal layer (1) may be lithium metal or a lithium alloy. Herein, the lithium alloy includes an element capable of alloying with lithium, and herein, the element may be Si, Sn, C, Pt, Ir, Ni, Cu, Ti, Na, K, Rb, Cs, Fr, Be, Mg, Ca, Sr, Sb, Pb, In, Zn, Ba, Ra, Ge, Al or an alloy thereof.

The lithium metal layer (1) may be a sheet or foil, and depending on cases, may have a form of depositing or coating lithium metal or lithium alloy on a current collector using a dry process, or may have a form of depositing or coating particulate metal and alloy using a wet process or the like.

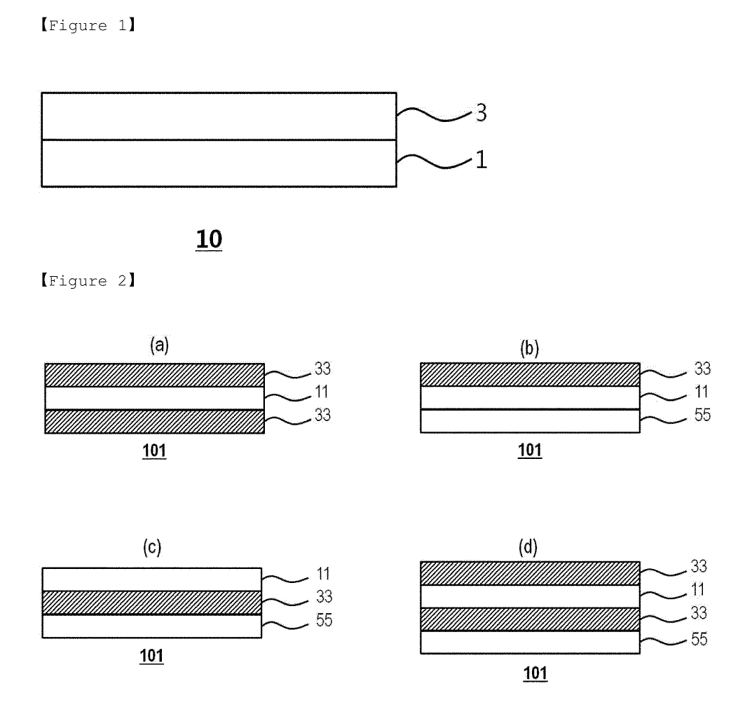

Herein, the passivation layer (3) may be located on one side surface of the lithium metal layer (1) as shown in FIG. 1, or the passivation layer (33) may be located on both side surfaces of the lithium metal layer (1) as shown in FIG. 2(a).

In addition, when using a current collector, the current collector (55) is disposed on one side of the lithium metal layer (11) and the passivation layer (33) is disposed on the other side as shown in FIG. 2(b), or, as shown in FIG. 2(c) and FIG. 2(d), a structure of disposing the passivation layer (33) between the lithium metal layer (11) and the current collector (55) may also be used. Such a structure is not particularly limited in the present invention, and disposition of various forms may be used in addition to the above-mentioned structures. Preferably, the passivation layer (33) is formed only one side surface of the lithium metal layer (11) when using a current collector (55), and the passivation layer (33) is formed on one side or both sides of the lithium metal layer (11) when a current collector (55) is not used.

Herein, the current collector is not particularly limited as long as it has conductivity without inducing chemical changes to a battery, and examples thereof may include copper, stainless steel, aluminum, nickel, titanium, baked carbon, copper or stainless steel of which surface is treated with carbon, nickel, titanium, silver and the like, aluminum-cadmium alloys, and the like. In addition, as the form, various forms such as films with/without micro-unevenness formed on the surface, sheets, foil, nets, porous bodies, foams and non-woven fabrics may be used.

Most preferably, the lithium metal layer (1) according to the present invention is a lithium metal sheet.

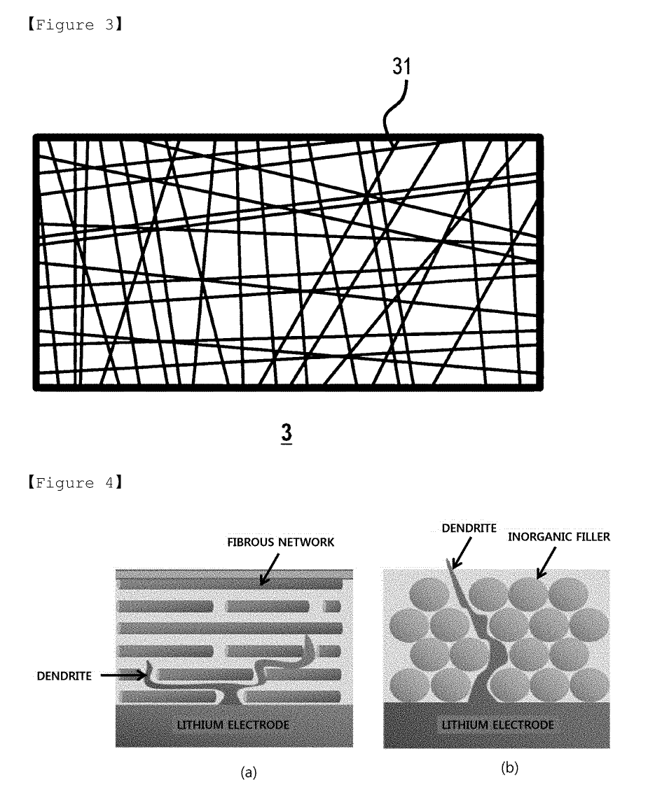

Particularly, the passivation layer (3) forming a lithium electrode (10) in the present invention includes a fibrous filler, and the fibrous filler forms a fibrous network structure. This will be described in more detail through a mimetic diagram of FIG. 3.

FIG. 3 is a mimetic diagram illustrating a constitution of a passivation layer (3) according to a first embodiment of the present invention. When referring to FIG. 3, a fibrous filler (31) is dispersed with diverse directivity in the passivation layer (3) to form a fibrous network structure, and the passivation layer (3) exhibits strength of certain level or higher due to the fibrous network structure. Such a fibrous network structure suppresses lithium dendrite growth on a lithium metal layer (1), and, even when lithium dendrite grows, physically suppresses the growth since the growth does not break through the dense structure of the fibrous network structure.

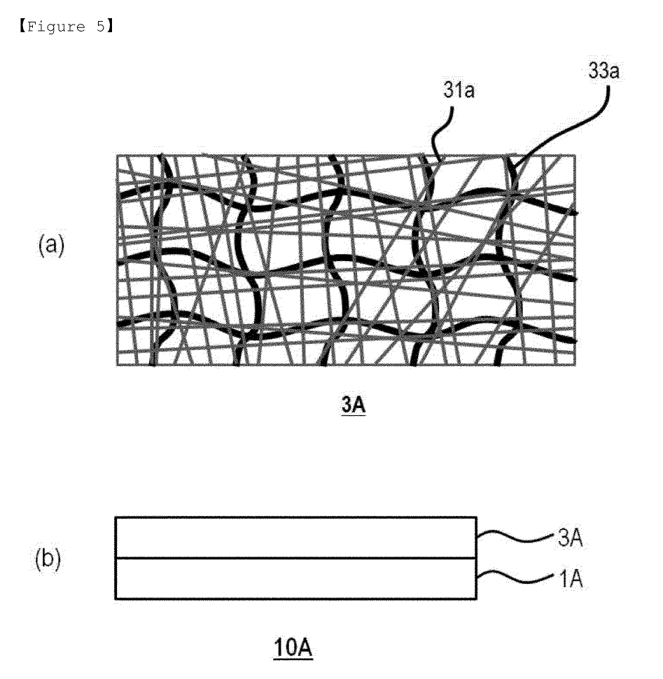

FIG. 4(a) is a mimetic diagram illustrating lithium dendrite growth in the fibrous filler in the lithium electrode (10) according to the present invention, and (b) is a mimetic diagram illustrating lithium dendrite growth in an existing inorganic filler.

When examining the mimetic diagram of FIG. 4, the passivation layer (3) of the present invention has a fibrous network structure, and even when lithium dendrite is produced, the lithium dendrite is not able to grow breaking through a dense fibrous network of the fibrous network, and therefore, the growth is fundamentally suppressed. In comparison, when using globular inorganic particles (refer to 4(b)), lithium dendrite produced on a lithium metal layer (1) continuously grows to empty space between the inorganic particles, breaks through a passivation layer (3) and touches a positive electrode causing a short circuit.

Moreover, the passivation layer (3) has excellent wettability for a liquid electrolyte.

Wettability refers to a phenomenon of a liquid spreading on a solid by an interaction between solid and liquid atoms when the liquid adheres on a surface of the solid. Surface energy of the passivation layer (3) is related to an affinity with a liquid electrolyte, and as affinity with a liquid electrolyte increases, permeation of the liquid electrolyte to the passivation layer (3) and furthermore to a lithium electrode (10) is commonly enhanced activating a battery reaction obtained by lithium ion migration and transfer. As a result, lithium ion transfer effectively occurs even at a high rate, and excellent battery properties are obtained without a battery short circuit and excellent charge and discharge properties are obtained without an increase in the resistance even with the formation of the passivation layer (3).

In order to secure the properties of the passivation layer (3) described above, that is, physical suppression of lithium dendrite growth and wettability for a liquid electrolyte, cellulose-based fibers are used as the fibrous filler (31).

Cellulose-based fibers have a hydroxyl group (OH) in the molecular structure as a reaction group, and thereby have high wettability for a liquid electrolyte, and may secure high mechanical strength by forming a three-dimensional structure in a fiber, particularly, a nanofiber form.

A material of the cellulose-based fiber provided in the present invention may be natural, regenerated or synthetic cellulose, and is not particularly limited in the present invention. As one example, the cellulose-based fiber may be alpha cellulose, beta cellulose, gamma cellulose, lignocellulose, pectocellulose, hemicellulose, carboxymethylcellulose, carboxyethylcellulose, hydroxymethylcellulose, hydroxyethylcellulose, cellulose acetate, cellulose acetate butyrate, cellulose acetate propionate, regenerated cellulose or the like.

Such a fibrous filler (31) does not have electrical conductivity compared to existing carbon nanotubes (CNT) or carbon nanofibers (CNF), and when having electrical conductivity like CNT or CNF, the fillers function as a current collector causing deinterlacation of a metal current collector and lithium metal, or lithium ions may locally migrate to or be present in where the conductive fillers are present causing a concern of inhibiting lithium ion transfer to a lithium electrode.

The fibrous filler (31) is preferably a nanofiber, and for forming a sufficient network structure, the average fiber diameter may be from 1 nm to 10 μm and the average fiber length may be from 100 nm to 500 μm. Herein, the average fiber length of the fibrous filler (31) is a value arithmetically averaging the length of each fiber, and may be calculated in the same manner as the average fiber diameter. When the fibrous filler (31) has an average fiber diameter and an average fiber length in the above-mentioned ranges, a stable network having excellent dispersion stability may be formed in a composition for forming a passivation layer during a preparing process.

In addition, the fibrous filler (31) forming a fibrous network structure of the passivation layer (3) according to the present invention may be one type selected from the group consisting of organic fillers, inorganic fillers and combinations thereof.

The organic filler may be an organic polymer fiber, and any material capable of being prepared to a fibrous form may be used. Typical examples thereof include one type selected from the group consisting of acryl-based fibers such as poly(meth)acrylate or polymethyl (meth) acrylate; amide-based fibers including polyamide; olefin-based fibers including polyethylene, polypropylene, cycloolefin or the like; ester-based fibers such as polyester, polyethylene terephthalate, polyethylene naphthalate, ethylene vinyl acetate or the like; urethane-based fibers such as polyurethane or polyether urethane; styrene-based fibers including polystyrene, ethylene-styrene copolymers, styrene-acrylonitrile or the like; imide-based fibers; and combinations thereof. The organic filler is flexible and is capable of more readily forming the fibrous network structure.

Polyacrylonitrile is one of the acryl-based fibers. The polyacrylonitrile is prepared using acrylonitrile as a monomer, and has low mechanical strength as a single polymer alone and thereby is normally used as a precursor for preparing a copolymer with other monomers or carbon fibers. When using the polyacrylonitrile, a property relating to lithium dendrite growth suppression, that is, nail penetration strength, is lower compared to cellulose, and therefore, the polyacrylonitrile is not included in present invention. Zheng et. al. proposed forming a protective layer using oxidized PAN for suppressing lithium dendrite through an article (Nano Lett. (2015), Vol. 15, No. 5, pp. 2910-2916), however, high enhancement was not accomplished in terms of tensile strength, and there was a problem of declining a wettability property due to an oxidation property.

Meanwhile, examples of the inorganic filler may include one type selected from the group consisting of alumina fibers, aluminosilicate fibers, silica fibers, aluminosilicate, aluminoborosilicate, mullite, magnesium silicate fibers, calcium magnesium silicate fibers and combinations thereof. The inorganic filler has high strength and thereby increases strength of a finally prepared passivation layer (3), and therefore, may more effectively suppress dendrite growth.

The thickness of the passivation layer (3) provided in the present invention is not particularly limited, has a range that does not increase internal resistance of a battery while securing the above-mentioned effects, and as one example, may be from 10 nm to 100 μm. When the thickness is less than the above-mentioned range, functions as the passivation layer (3) may not be performed, and when the thickness is greater than above-mentioned range, initial interfacial resistance increases although stable interfacial properties are obtained, which may cause an increase in the internal resistance when manufacturing a battery.

The preparation of the lithium electrode (10) having a structure according to the first embodiment is not particularly limited in the present invention, and known methods or various methods modifying these methods may be used by those skilled in the art.

As one example, a composition for forming a passivation layer in which a fibrous filler (31) is dispersed into a solvent is prepared, and the composition is coated on a substrate and then dried to prepare a passivation layer (3). The prepared passivation layer (3) may be transferred or laminated on a lithium metal layer (1) to prepare a lithium electrode (10).

Herein, as the solvent, any solvent may be used as long as it is capable of uniformly dispersing the fibrous filler (31). As one example, the solvent may be a mixed solvent of water and alcohol, or one or more organic solvent mixtures. In this case, the alcohol may be a lower alcohol having 1 to 6 carbon atoms, and preferably methanol, ethanol, propanol, isopropanol or the like. As the organic solvent, polar solvents such as acetic acid, dimethyl-formamide (DMF) and dimethyl sulfoxide (DMSO), or nonpolar solvents such as acetonitrile, ethyl acetate, methyl acetate, fluoroalkane, pentane, 2,2,4-trimethylpentane, decane, cyclohexane, cyclopentane, diisobutylene, 1-pentene, 1-chlorobutane, 1-chloropentane, o-xylene, diisopropyl ether, 2-chloropropane, toluene, 1-chloropropane, chlorobenzene, benzene, diethyl ether, diethyl sulfide, chloroform, dichloromethane, 1,2-dichloroethane, aniline, diethylamine, ether, carbon tetrachloride and tetrahydrofuran (THF) may be used.

As for the solvent content, the solvent may be included at a level having a concentration to readily carry out coating, and the specific content varies depending on coating methods and devices.

When using a method such as transfer, the substrate may be a separable substrate, that is, a glass substrate or a plastic substrate. Herein, the plastic substrate is not particularly limited in the present invention, and may be polyarylate, polyethylene terephthalate (PET), polybutylene terephthalate (PBT), polysilane, polysiloxane, polysilazane, polyethylene (PE), polycarbosilane, polyacrylate, poly(meth)acrylate, polymethyl acrylate, polymethyl (meth)acrylate (PMMA), polyethyl acrylate, a cyclic olefin copolymer (COC), polyethyl(meth)acrylate, a cyclic olefin polymer (COP), polypropylene (PP), polyimide (PI), polystyrene (PS), polyvinyl chloride (PVC), polyacetal (POM), polyetheretherketone (PEEK), polyester sulfone (PES), polytetrafluoroethylene (PTFE), polyvinylidene fluoride (PVDF), a perfluoroalkyl polymer (PFA) or the like.

The coating in this step is not particularly limited, and any method may be used as long as it is a known wet coating method. As one example, a method of uniformly dispersing using a doctor blade and the like, a method of die casting, comma coating, screen printing or the like may be used.

Subsequently, a drying process for removing the solvent is carried out after the coating. The drying process is carried out with temperature and time capable of sufficiently removing the solvent, and the condition is not particularly mentioned in the present invention since it may vary depending on the solvent type. As one example, the drying may be carried out in a vacuum oven at 30° C. to 200° C., and as the drying method, drying methods such as drying by warm air, hot air or low humidity air, or vacuum drying may be used. The drying time is not particularly limited, however, the drying is commonly carried out in a range of 30 seconds to 24 hours.

By controlling a concentration, the number of coating, or the like of the composition for forming a passivation layer according to the present invention, a coating thickness of the finally coated passivation layer (3) may be controlled.

Additionally, the passivation layer (3) according to the present invention further enhances strength for suppressing lithium dendrite growth, or further includes additional materials for more smoothly performing lithium ion transfer. As the composition that may be added, one type selected from the group consisting of an ion conductive polymer, a lithium salt, inorganic oxide particles and a mixture of two or more types thereof may be used.

FIG. 5 is (a) a mimetic diagram illustrating a constitution of a passivation layer (3A), and (b) a sectional diagram of a lithium electrode including the same according to a second embodiment of the present invention.

When referring to FIG. 5, a passivation layer (3A) according to the second embodiment has a double network structure forming, together with a network formed with a fibrous filler (31a), another network structure by an ion conductive polymer (33a) being crosslinked.

By the ion conductive polymer (33a) being crosslinked to form a network structure, the passivation layer (3A) having this network structure has more increased strength and physically suppresses lithium dendrite growth. In addition, due to lithium ion hopping mechanism obtained by an ion conductive property, a function of lithium ion transfer between a liquid electrolyte and a lithium metal layer (1) is obtained.

The ion conductive polymer (33a) has a weight average molecular weight of 100 g/mol to 10,000,000 g/mol, the type is not particularly limited in the present invention, and any material commonly used in the art may be used. As one example, the ion conductive polymer (33) may be one type selected from the group consisting of polyethylene oxide, polypropylene oxide, polydimethylsiloxane, polyacrylonitrile, polymethyl (meth)acrylate, polyvinyl chloride, polyvinylidene fluoride, polyvinylidene fluoride-co-hexafluoropropylene, polyethylene imine, polyphenylene terephthalamide, polymethoxypolyethylene glycol (meth)acrylate, poly-2-methoxyethyl glycidyl ether and combinations thereof, and preferably, polyethylene oxide is used.

The ion conductive polymer (33a) is introduced to the passivation layer (3A) in a crosslinked form, and herein, as for the crosslinking, a crosslinkable functional group is present in the ion conductive polymer (33a) and performs crosslinking between these, or a crosslinking method using a separate crosslinking agent may be used.

The crosslinkable functional group is a functional group having at least three or more ethylenically unsaturated bonds in the molecular structure, and the functional group or a compound including the functional group may chemically bond to the ion conductive polymer (33a) for the crosslinking.

As the crosslinking agent, compounds having at least three or more ethylenically unsaturated bonds in the molecular structure are used.

Examples of the difunctional crosslinking agent may include 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, dicyclopentanyl di(meth)acrylate, caprolactone-modified dicyclopentenyl di(meth)acrylate, ethylene oxide-modified di(meth)acrylate, tricyclodecane dimethanol (meth) acrylate, dimethylol dicyclopentane di(meth)acrylate, tricyclodecane dimethanol (meth) acrylate, neopentylglycol-modified trimethylpropane di(meth)acrylate, polyethylene glycol di(meth)acrylate, polyethylene glycol diacrylate, divinylbenzene, polyester di(meth)acrylate, divinyl ether, ethoxylated bisphenol A di(meth)acrylate or the like. Examples of the trifunctional crosslinking agent may include trimethylolpropane tri(meth)acrylate, trimethylolpropane ethoxylated tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trimethylolpropane, trimethylolpropane tri(meth)acrylate or the like. Examples of the tetrafunctional crosslinking agent may include diglycerin tetra(meth)acrylate, pentaerythritol tetra(meth)acrylate or the like, examples of the pentafunctional crosslinking agent may include propionic acid-modified dipentaerythritol penta(meth)acrylate or the like, and examples of the hexafunctional crosslinking agent may include dipentaerythritol hexa(meth)acrylate, caprolactone-modified dipentaerythritol hexa(meth)acrylate or the like.

In order to increase ion conductivity of lithium ions, those having an ethylene oxide functional group in the molecular structure are preferably used, and more preferably, polyethylene glycol dimethacrylate, polyethylene glycol diacrylate, trimethylolpropane ethoxylated triacrylate, trimethylolpropane trimethacrylate or the like is used.

Herein, the content of the crosslinking agent is directly related to layer strength of the passivation layer (3A), and the crosslinking agent is preferably used in 5 parts by weight to 200 parts by weight with respect to 100 parts by weight of the ion conductive polymer. When the crosslinking agent is used in a content higher than the above-mentioned range, strength of the passivation layer (3A) increases becoming breakable or causing damages, and when used in a content lower than the above-mentioned range, strength of the passivation layer (3A) is low causing a concern of damages caused by a liquid electrolyte, and therefore, the crosslinking agent content is properly controlled in order to secure optimal layer strength.

The ion conductive polymer (33a) content is greater than or equal to 0 parts by weight and less than or equal to 5000 parts by weight, preferably from 50 parts by weight to 1000 parts by weight and more preferably from 70 parts by weight to 700 parts by weight with respect to 100 parts by weight of the fibrous filler. When the ion conductive polymer (33a) content is greater than above-mentioned range, the fibrous filler content relatively decreases and a strength enhancing effect obtained therefrom may not be secured, which makes it difficult to expect an effect of physically suppressing lithium dendrite, and therefore, the content is properly controlled within the above-mentioned range.

The ion conductive polymer (33a) is added to the composition for forming a passivation layer mentioned in the first embodiment, and as necessary, a crosslinking agent, an initiator, an initiation aid and the like may be further added.

Specifically, the preparation of the lithium electrode (10A) according to the second embodiment is carried out by adding a fibrous filler (31a), an ion conductive polymer (33a) and, selectively, a crosslinking agent, an initiator, an initiation aid, a solvent and the like to a solvent, coating the result on a substrate, and performing a crosslinking process to form a passivation layer (3A), and transferring or laminating the passivation layer (3A) on a lithium metal layer (1A).

The initiator that may be used varies depending on the crosslinking reaction, and known photoinitiators or thermal initiators may all be used. Examples of the photoinitiator may include benzoin, benzoin ethyl ether, benzoin isobutyl ether, alphamethyl benzoin ethyl ether, benzoin phenyl ether, acetophenone, dimethoxyphenyl acetophenone, 2,2-diethoxyacetophenone, 1,1-dichloroacetophenone, trichloroacetophenone, benzophenone, p-chlorobenzophenone, 2,4-dihydroxybenzophenone, 2-hydroxy-4-methoxybenzophenone, 2-hydroxy-2-methylpropiophenone, benzyl benzoate, benzoyl benzoate, anthraquinone, 2-ethylanthraquinone, 2-chloroanthraquinone, 2-methyl-1-(4-methylthiophenyl)-morpholinopropanone-1,2-hydroxy-2-methyl-1-phenylpropan-1-one (Darocure 1173 manufactured by CIba Geigy), Darocure 1116, Irgacure 907, 2-benzyl-2-dimethylamino-1-(4-morpholinophenyl)-butanone-1,1-hydroxycyclohexylphenyl ketone (Irgacure 184 manufactured by CIba Geigy), michler's ketone, benzyl dimethyl ketal, thioxanthone, isopropyl thioxanthone, chlorothioxanthone, benzyl, benzyl disulfide, butanediol, carbazole, fluorenone, alphaacyloxime ester and the like, and examples of the thermal initiator may include peroxide (—O—O—) series benzoyl peroxide, acetyl peroxide, dilauryl peroxide, di-tert-butyl peroxide, cumyl hydroperoxide and the like, and azo-based compound (—N═N—) series azobisisobutyronitrile, azobisisovaleronitrile and the like may be used.

The content of the initiator is not particularly limited in the present invention, and is preferably in a range that does not affect properties as a polymer passivation layer, an electrode and a liquid electrolyte, and as one example, the initiator is used in a range of 1 parts by weight to 15 parts by weight with respect to 100 parts by weight of the ion conductive polymer.

As the solvent, those capable of dissolving the ion conductive polymer (33a) are used, and those that are the same as the solvent used for dispersing the fibrous filler (31a) or have compatibility with this solvent are used.

The crosslinking process may be carried out by applying heat or irradiating active energy rays, and herein, the crosslinking by heat may use a method of heating, and the active energy rays may be through irradiating far-infrared rays, ultraviolet rays or an electron beam. As shown in FIG. 3, the ion conductive polymer and the crosslinking agent chemically bond and are converted to a matrix having a network structure through such a crosslinking process, and the fibrous filler (31) also forms a fibrous network therein.

Specifically, thermal crosslinking may be carried out at a temperature of 50° C. to 200° C. and more preferably at a temperature of 80° C. to 110° C. In addition, the heating time for the crosslinking is preferably from 30 minutes to 48 hours and more preferably from 8 hours to 24 hours. When the heating temperature and time are less than the above-mentioned ranges, crosslinking is difficult to be sufficiently formed, and when the heating temperature and time are greater than the above-mentioned ranges, side reactions may occur, or material stability may decrease.

In addition, photocrosslinking including active energy ray irradiation is carried out for 10 seconds to 5 hours and more preferably for 5 minutes to 2 hours. When the time of active energy ray irradiation is less than the above-mentioned range, crosslinking is difficult to be sufficiently formed, and when the time is greater than the above-mentioned range, side reactions may occur, or material stability may decrease.

As necessary, specific conditions for the thermal crosslinking and the photocrosslinking may be set differently depending on whether each method is carried out alone or is carried out as a combination.

A cooling process may be further carried out after the crosslinking process as necessary.

The cooling process further increases density of the crosslinked ion conductive polymer organization and may have the network structure firmer, and may be preferably carried out in a manner of slowly cooling to room temperature.

Moreover, a rolling process used in common electrode preparation processes may be carried out after the cooling process.

The rolling process is for increasing adhesion between the prepared lithium metal layer (1) and the passivation layer (3), and includes processes of passing through the electrode between two rotating rolls or disposing the electrode between a flat press machine, and compressing the electrode with a specific pressure. Herein, the rolling process may be carried out with heating to a specific temperature.

Such a cooling process and a rolling process may also be carried out in the first embodiment in the same manner.

Additionally, the passivation layer (3A) according to the second embodiment may further include a lithium salt in order to increase ion conductivity. The lithium salt may be used together with the ion conductive polymer and/or the particulate filler, or may be used alone, and preferably, used together with the ion conductive polymer.

The lithium salt is not particularly limited in the present invention, and any material capable of being used in all-solid-state batteries among known lithium secondary batteries may be used. Specifically, as the lithium salt, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, (FSO₂)₂NLi, chloroborane lithium, lower aliphatic carboxylic acid lithium, lithium tetraphenylborate, lithium imide or the like may be used, and preferably, lithium bis(trifluoromethane sulfonyl)imide (LiTFSI) represented by (CF₃SO₂)₂NLi may be used.

Preferably, the lithium salt is used together with the ion conductive polymer, and herein, the lithium salt is used in 1 parts by weight to 100 parts by weight with respect to 100 parts by weight of the ion conductive polymer.

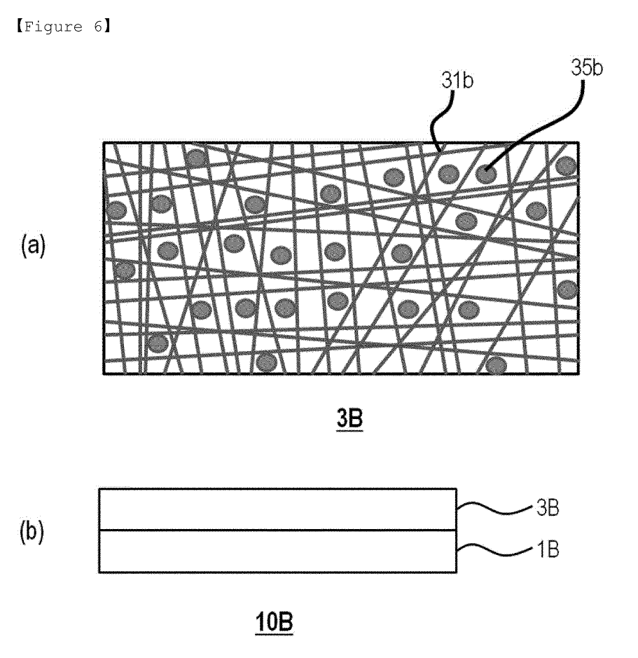

FIG. 6 is (a) a mimetic diagram illustrating a constitution of a passivation layer (3B), and (b) a sectional diagram of a lithium electrode including the same according to a third embodiment of the present invention.

When referring to FIG. 6(a), the passivation layer (3B) according to the third embodiment has a structure of, together with a network formed with a fibrous filler (31b), a particulate filler (35b) being inserted between the fibrous fillers (31b).

The fibrous filler (31b) forms a dense network structure when introduced to the passivation layer (3B) due to unique fiber properties. Such a network structure has an advantage of high strength, but is somewhat disadvantageous in terms of lithium ion transfer. Accordingly, when the particulate filler (35b) is inserted into the fibrous network, space is formed due to the particulate filler (35b), and lithium ions freely migrate through such space resultantly further increasing a speed of lithium ion transfer. Moreover, the particulate filler (35b) may further contribute to lithium dendrite suppression by increasing strength of the passivation layer (3B).

The particulate filler (35b) provided in the present invention includes one type selected from the group consisting of organic particles, inorganic particles and combinations thereof, and uses materials that are electrically insulating and/or do not have ion conductivity.

Examples of the organic particles may include olefin-based polymers such as polyethylene or polypropylene, acrylate-based polymers such as polyacrylate or polymethyl methacrylate, fluoro-based polymers such as polytetrafluoroethylene (PTFE), polyvinylidene fluoride (PVDF) or perfluoroalkyl polymers (PFA), ester-based polymers such as polyethylene terephthalate (PET) or polybutylene terephthalate (PBT), siloxane-based polymers such as polysiloxane, polysilazane, polyethylene (PE) or polycarbosilane, and the like.

As the inorganic particles, one type selected from the group consisting of alumina, silica, titania, zirconia, zinc oxide, antimony oxide, ceria, talc, forsterite, potassium carbonate, aluminum hydroxide, talcum, clay, talcum, barium sulfate, zeolite, kaolin, mica, montmorillonite, silicon nitride, boron nitride, barium titanate and combinations thereof may be used.

The particulate filler (35b) has an average particle diameter of 1 nm to 5 μm and preferably 5 nm to 1 μm. When the average particle diameter is less than the above-mentioned range, the particulate filler (35) aggregates with each other making it difficult to secure uniform properties, and when the average particle diameter is greater than above-mentioned range, the particulate filler is difficult to be inserted between the fibrous fillers (31b), and therefore, the average particle diameter is properly employed in the above-mentioned range.

The content of the particulate filler (35b) is greater than 0 parts by weight and less than or equal to 100 parts by weight, preferably from 1 parts by weight to 50 parts by weight and more preferably from 5 parts by weight to 20 parts by weight with respect to 100 parts by weight of the fibrous filler. When the particulate filler (35b) content is greater than the above-mentioned range, separation with the fibrous filler (35b) occurs in the passivation layer (3B) preparation process, or strength of the passivation layer (3B) increases too much making the process of transferring or laminating the passivation layer (3B) on the lithium metal layer (1B) difficult, and therefore, the content is properly controlled in the above-mentioned range.

Such a preparation of the lithium electrode (10B) according to the third embodiment is carried out by adding fibrous filler (31b) and a particulate filler (35b) to a solvent, coating the result on a substrate, and performing a crosslinking process to form a passivation layer (3B), and transferring or laminating the passivation layer (3A) on a lithium metal layer (1B).

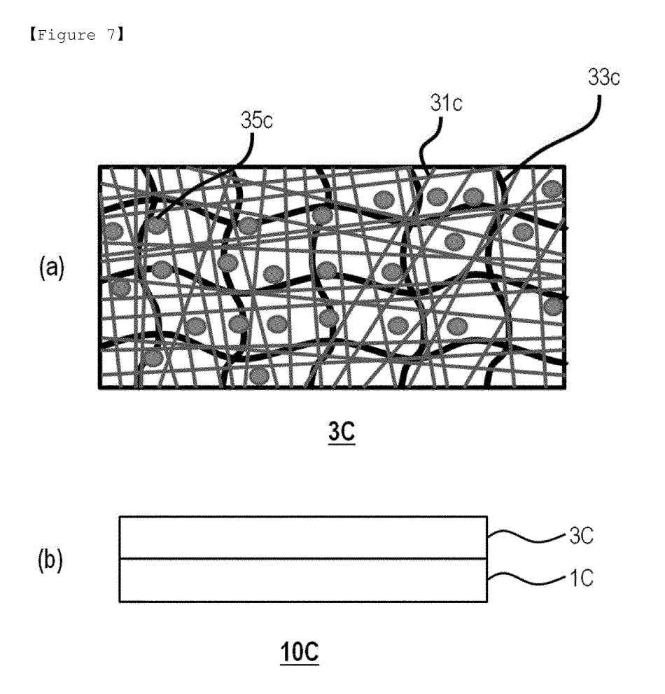

FIG. 7 is (a) a mimetic diagram illustrating a constitution of a passivation layer (3C), and (b) a sectional diagram of a lithium electrode including the same according to a fourth embodiment of the present invention.

The passivation layer (3C) according to FIG. 7 includes, together with a fibrous filler (31c), both the ion conductive polymer (33c) and the particulate filler (35c) described above. With the use of the above-mentioned composition, such a structure of the passivation layer (3C) according to the third embodiment secures effects of effectively suppressing lithium dendrite growth and smoothly transferring lithium ions.

Specific details on each of the compositions and each of the preparation methods follow descriptions provided in the second embodiment and the third embodiment.

Lithium Secondary Battery

In addition, the present invention provides a lithium secondary battery including a positive electrode, a negative electrode, a separator provided between the electrodes, and a liquid electrolyte, wherein the passivation layer for a lithium electrode described above is disposed between the negative electrode and the separator.

Herein, the passivation layer is disposed so as to adjoin one side surface of the negative electrode, and is present in a transferred or laminated form on the negative electrode rather than in a coated form.

Such a lithium secondary battery has excellent battery properties without a battery short circuit even at a high rate, and has excellent charge and discharge properties without an increase in the resistance even with passivation layer formation. Such a lithium secondary battery has no chance of explosion or fire at an existing high rate and is considered to be suitable for commercialization.

The positive electrode has a form in which a positive electrode active material is laminated on a positive electrode current collector.

The positive electrode current collector is not particularly limited as long as it has high conductivity without inducing chemical changes to a battery, and examples thereof may include stainless steel, aluminum, nickel, titanium, baked carbon, or aluminum or stainless steel of which surface is treated with carbon, nickel, titanium, silver and the like.

The positive electrode active material may vary depending on the application of a lithium secondary battery, and known materials are used as the specific composition. As one example, the positive electrode active material may include any one lithium transition metal oxide selected from the group consisting of lithium cobalt-based oxides, lithium manganese-based oxides, lithium copper oxide, lithium nickel-based oxides, lithium manganese composite oxides and lithium-nickel-manganese-cobalt-based oxides, and more specifically, may include lithium manganese oxides such as Li₁₊ₓMn₂₋ₓO₄ (herein, x is 0 to 0.33), LiMnO₃, LiMn₂O₃ or LiMnO₂; lithium copper oxide (Li₂CuO₂); vanadium oxides such as LiV₃O₈, LiFe₃O₄, V₂O₅ or Cu₂V₂O₇; lithium nickel oxides represented by LiNi₁₋ₓMxO₂ (herein, M═Co, Mn, Al, Cu, Fe, Mg, B or Ga, and x=0.01 to 0.3); lithium manganese composite oxides represented by LiMn₂₋ₓMₓO₂ (herein, M═Co, Ni, Fe, Cr, Zn or Ta, and x=0.01 to 0.1) or Li₂Mn₃MO₈ (herein, M═Fe, Co, Ni, Cu or Zn), lithium-nickel-manganese-cobalt-based oxides represented by Li(NiₐCo_{b}Mn_{c})O₂ (herein, 0<a<1, 0<b<1, 0<c<1, a+b+c=1), Fe₂(MoO₄)₃; elemental sulfur, disulfide compounds, organosulfur compounds and carbon-sulfur polymers ((C₂Sₓ)ₙ: x=2.5 to 50, n≥2); graphite-based materials; carbon black-based materials such as Super-P, denka black, acetylene black, ketjen black, channel black, furnace black, lamp black, thermal black or carbon black; carbon derivatives such as fullerene; conductive fibers such as carbon fiber or metal fiber; fluorinated carbon, aluminum, metal powder such as nickel powder; conductive polymers such as polyaniline, polythiophene, polyacetylene or polypyrrole; forms supporting a catalyst such as Pt or Ru on a porous carbon support, or the like. However, the positive electrode active material is not limited thereto.

The conductor is used for further enhancing conductivity of the electrode active material. Such a conductor is not particularly limited as long as it has conductivity without inducing chemical changes to the corresponding battery, and examples thereof may include graphite such as natural graphite or artificial graphite; carbon black such as carbon black, acetylene black, ketjen black, channel black, furnace black, lamp black or thermal black; conductive fibers such as carbon fiber or metal fiber; fluorinated carbon, aluminum, metal powder such as nickel powder; conductive whiskers such as zinc oxide or potassium titanate; conductive metal oxides such as titanium oxide; polyphenylene derivatives and the like.

The positive electrode may further include a binder for binding of the positive electrode active material and the conductor and for binding on the current collector. The binder may include a thermoplastic resin or a thermosetting resin. For example, polyethylene, polypropylene, polytetrafluoroethylene (PTFE), polyvinylidene fluoride (PVDF), styrene-butadiene rubber, a tetrafluoroethylene-perfluoro alkylvinyl ether copolymer, a vinylidene fluoride-hexafluoropropylene copolymer, a vinylidene fluoride-chlorotrifluoroethylene copolymer, an ethylene-tetrafluoroethylene copolymer, a polychlorotrifluoroethylene, vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinyl ether-tetrafluoroethylene copolymer, an ethylene-acrylic acid copolymer and the like may be used either alone or as a mixture, however, the binder is not limited thereto, and those capable of being used as a binder in the art may all be used.

Such a positive electrode may be prepared using common methods, and specifically, may be prepared by coating a composition for forming a positive electrode active material layer prepared by mixing a positive electrode active material, a conductor and a binder in an organic solvent on a current collector and drying the result, and selectively, compression molding the result on the current collector for enhancing electrode density. Herein, as the organic solvent, those capable of uniformly dispersing the positive electrode active material, the binder and the conductor, and readily evaporating are preferably used. Specifically, acetonitrile, methanol, ethanol, tetrahydrofuran, water, isopropyl alcohol and the like may be included.

A common separator may be provided between the positive electrode and the negative electrode. The separator is a physical separator having a function of physically separating electrodes, and those commonly used as a separator may be used without particular limit, and particularly, those having an excellent electrolyte moisture retention ability while having low resistance for ion migration of the liquid electrolyte are preferred.

In addition, the separator enables lithium ion transfer between the positive electrode and the negative electrode while separating or insulating the positive electrode and the negative electrode from each other. Such a separator may be formed with porous, and non-conductive or insulating materials. The separator may be an independent member such as a film, or a coating layer added to the positive electrode and/or the negative electrode.

Specifically, porous polymer films, for example, porous polymer films prepared with a polyolefin-based polymer such as an ethylene homopolymer, a propylene homopolymer, an ethylene/butene copolymer, an ethylene/hexene copolymer and an ethylene/methacrylate copolymer may be used either alone or as laminates thereof, or common porous non-woven fabrics, for example, non-woven fabrics made of high melting point glass fiber, polyethylene terephthalate fiber or the like may be used, however, the separator is not limited thereto.

The liquid electrolyte of the lithium secondary battery is a lithium-salt containing liquid electrolyte, and may be an aqueous or non-aqueous liquid electrolyte, and is preferably a non-aqueous electrolyte formed with an organic solvent liquid electrolyte and a lithium salt. In addition thereto, an organic solid electrolyte, an inorganic solid electrolyte or the like may be included, however, the liquid electrolyte is not limited thereto.

Examples of the non-aqueous organic solvent may include aprotic organic solvents such as N-methyl-2-pyrrolidinone, propylene carbonate, ethylene carbonate, butylene carbonate, dimethyl carbonate, diethyl carbonate, ethylmethyl carbonate, gamma-butyrolactone, 1,2-dimethoxyethane, 1,2-diethoxyethane, tetrahydroxy franc, 2-methyltetrahydrofuran, dimethyl sulfoxide, 1,3-dioxolane, 4-methyl-1,3-dioxene, diethyl ether, formamide, dimethylformamide, dioxolane, acetonitrile, nitromethane, methyl formate, methyl acetate, phosphoric acid triester, trimethoxymethane, dioxolane derivatives, sulfolane, methylsulfolane, 1,3-dimethyl-2-imidazolidinone, propylene carbonate derivatives, tetrahydrofuran derivatives, ethers, methyl propionate or ethyl propionate.

Herein, ether-based solvents are used as the non-aqueous solvent so as to be similar to the electrode passivation layer of the present invention, and examples thereof may include tetrahydrofuran, ethylene oxide, 1,3-dioxolane, 3,5-dimethyl isoxazole, 2,5-dimethylfuran, furan, 2-methylfuran, 1,4-oxane, 4-methyl dioxolane and the like.

The lithium salt is a material to be favorably dissolved in the non-aqueous electrolyte, and examples thereof may include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃ (CF₃SO₂)₂NLi, (FSO₂)₂NLi, chloroborane lithium, lower aliphatic carboxylic acid lithium, lithium tetraphenylborate, lithium imide and the like.

With the purpose of improving charge and discharge properties and flame retardancy, for example, pyridine, triethylphosphite, triethanolamine, cyclic ether, ethylenediamine, n-glyme, hexaphosphoric acid triamide, nitrobenzene derivatives, sulfur, quinoneimine dyes, N-substituted oxazolidinone, N,N-substituted imidazolidine, ethylene glycol dialkyl ether, ammonium salts, pyrrole, 2-methoxyethanol, aluminum trichloride may also be added to the non-aqueous electrolyte. In some cases, halogen-containing solvents such as carbon tetrachloride and trifluoroethylene may be further included in order to provide nonflammability, and carbon dioxide gas may be further included in order to enhance high temperature storage properties.

The form of the lithium secondary battery described above is not particularly limited, and examples thereof may include a jelly-roll type, a stack type, a stack-folding type (including stack-Z-folding type) or a lamination-stack type, and may preferably be a stack-folding type.

After preparing an electrode assembly having the positive electrode, the separator and the negative electrode consecutively laminated, the electrode assembly is placed in a battery case, the liquid electrolyte is injected to the top of the case, and the result is sealed with a cap plate and a gasket and then assembled to manufacture a lithium secondary battery.

Herein, depending on the positive electrode material and the separator type, the lithium secondary battery may be divided into various batteries such as a lithium-sulfur battery, a lithium-air battery, a lithium-oxide battery or a lithium all-solid-state battery, and depending on the shape, may be divided into a cylinder-type, a square-type, a coin-type, a pouch-type and the like, and depending on the size, may be divided into a bulk type and a thin film type. Structures and manufacturing methods of these batteries are widely known in the art, and therefore, detailed descriptions thereon are not included.

The lithium secondary battery according to the present invention may be used as a power supply of devices requiring high capacity and high rate properties. Specific examples of the device may include power tools operated through receiving electric power by a battery motor; electric vehicles including electric vehicles (EV), hybrid electric vehicles (HEV), plug-in hybrid electric vehicles (PHEV) and the like; electric two-wheeled vehicles including e-bikes, e-scooters and the like; electric golf carts; systems for power storage and the like, but are not limited thereto.

Hereinafter, examples, comparative examples and experimental examples are described in order to illuminate effects of the present invention. However, the following descriptions are just one example of contents and effects of the present invention, and the scope of a right and effects of the present invention are not limited thereto.

### EXAMPLE 1

### Manufacture of Lithium Secondary Battery

(1) Preparation of Lithium Electrode

After pouring 10 ml of an aqueous cellulose nanofiber (CLNF, average diameter 50 nm, average length 1 μm) solution (0.125% by weight) on a membrane filter made of a nylon material as a fibrous filler, a film formed on the filter was dried for 12 hours in a vacuum oven at 60° C. to prepare a passivation layer having a thickness of 10 μm.

The passivation layer was transferred on lithium metal having a thickness of 150 μm through rolling to prepare a lithium electrode.

(2) Manufacture of Lithium Secondary Battery

For battery performance evaluation, a lithium/lithium battery (symmetric cell) using lithium as both a negative electrode and a positive electrode was manufactured.

After inserting an electrode assembly provided with a polyolefin-based porous membrane between the lithium electrode prepared in (1) and, as a positive electrode, a lithium metal sheet having a thickness of 150 μm into a pouch-type battery case, a non-aqueous liquid electrolyte (1 M LiFSI, DOL:DME=1:1 (volume ratio)) was injected into the battery case, and the result was completely sealed to manufacture a lithium secondary battery. Herein, DOL is dioxolane and DME is dimethoxyethane.

### EXAMPLE 2

### Manufacture of Lithium Secondary Battery

A passivation layer and a lithium secondary battery were prepared in the same manner as in Example 1, except that the passivation layer was prepared using a method provided below.

Polyethylene oxide (PEO, Mv: 4,000,000 g/mol) was dissolved in acetonitrile in a concentration of 4% by weight. A polyethylene glycol diacrylate (PEGDA, crosslinking agent, Mn: 575 g/mol) solution dissolving 1% by weight of benzoyl peroxide was added thereto as an initiator and the result was quantized so that the polyethylene oxide content became 50% by weight.

An aqueous fibrous filler solution (cellulose nanofibers (CLNF), 1% by weight) was added thereto and the result was uniformly mixed. In the obtained mixed solution, PEO/PEGDA/CLNF were employed to have a weight ratio of 2/1/1.

Subsequently, the obtained solution was coated on a PTFE substrate using doctor blade, and the result was dried for 10 minutes at 50° C. and 2 hours under vacuum. Next, the obtained layer was cured for 12 hours in a vacuum oven at 80° C. to prepare a passivation layer having a thickness of 10 μm.

### EXAMPLE 3

### Manufacture of Lithium Secondary Battery

A passivation layer and a lithium secondary battery were prepared in the same manner as in Example 1, except that the passivation layer was prepared using a method provided below.

After mixing 10 ml of a cellulose nanofiber (CLNF) solution (0.125% by weight) and 10 ml of an aqueous alumina (10 nm, globular) solution (0.006% by weight) as a fibrous filler, and then pouring the obtained mixed solution on a membrane filter made of a nylon material, a film formed on the filter was dried for 12 hours in a vacuum oven at 60° C. to prepare a passivation layer having a thickness of 10 pm.

### COMPARATIVE EXAMPLE 1

### Manufacture of Lithium Secondary Battery

A battery was manufactured in the same manner as in Example 1 except that the passivation layer was not formed.

### COMPARATIVE EXAMPLE 2

### Manufacture of Lithium Secondary Battery

A battery was manufactured in the same manner as in Example 1 except that carbon nanotubes (CNT) were used as the passivation layer.

### EXPERIMENTAL EXAMPLE 1

### Evaluation on Lithium Secondary Battery

(1) Surface Property Evaluation

After manufacturing the lithium secondary batteries as in the examples and the comparative examples, each of the batteries was charged and discharged 10 times under a condition of 3 mA. Then, lithium metal (negative electrode) was separated from the battery in order to identify lithium dendrite formation.

FIG. 8 shows images of lithium metal prepared in (a) Example 1, (b) Example 2, (c) Example 3, (d) Comparative Example 1 (bare Li) and (e) Comparative Example 2.

When examining (a) to (c) of FIG. 8, the lithium metal of Examples 1 to 3 forming a passivation layer according to the present invention had a very smooth surface shape, whereas the electrode of Comparative Example 1 had a rough surface, and Comparative Example 2 had a serious shape change.

In order to more clearly identify the surface, the surface was measured using an optical microscope and a scanning electron microscope.

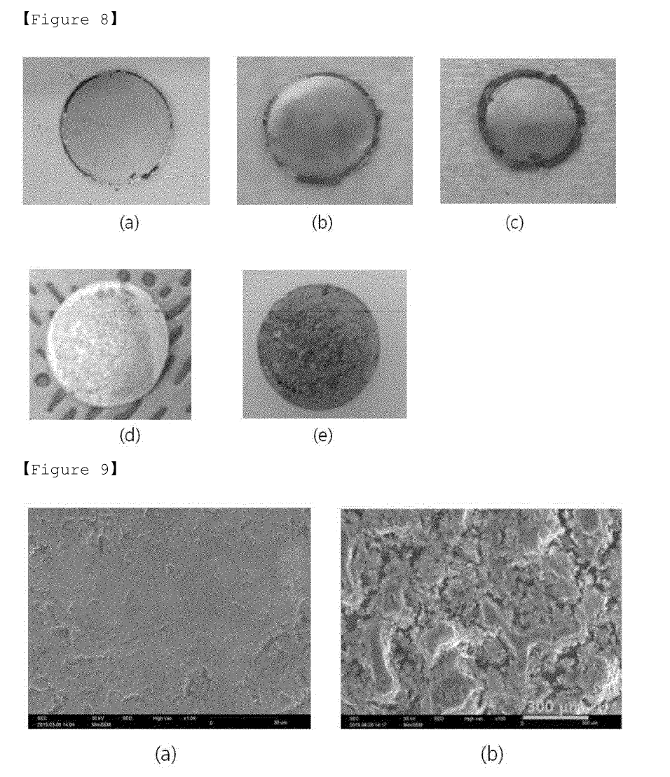

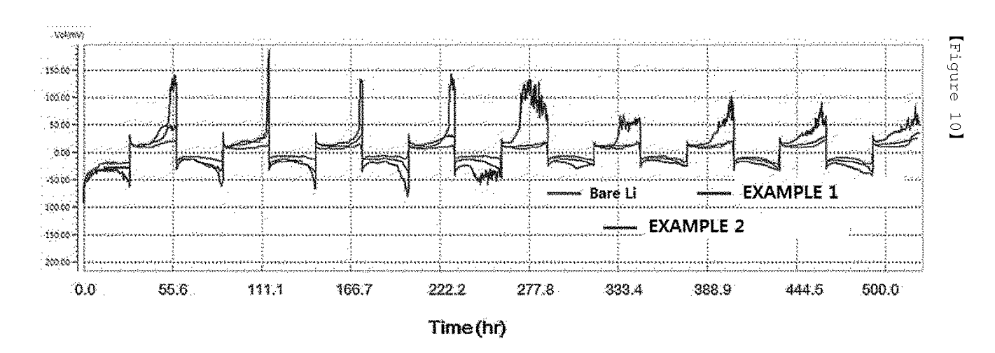

FIG. 9 shows scanning electron microscope images of the lithium electrodes in the batteries of (a) Example 1 and (b) Comparative Example 1 (bare Li).

When examining the scanning electron microscope images of FIG. 9, it was seen that the electrode surface in Example 1 had a smooth shape, whereas Comparative Example 1 had very rough unevenness formed on the whole surface.

(2) Overvoltage Measurement

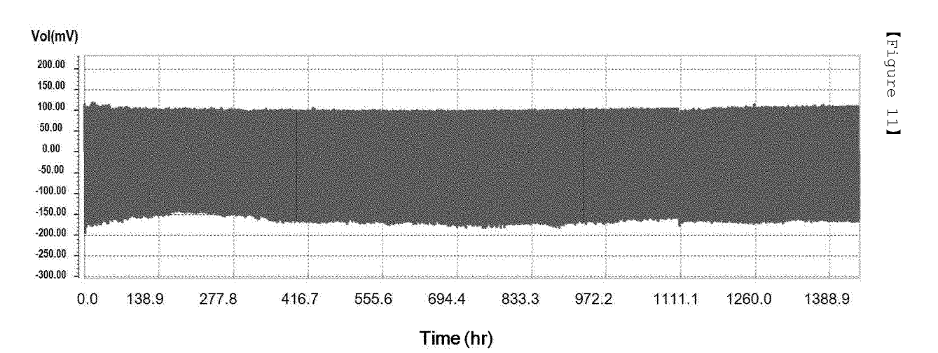

For each of the lithium secondary batteries manufactured in the examples and the comparative examples, an overvoltage was measured, and the results are shown in FIG. 10.

FIG. 10 is a graph comparing an overvoltage during 10 cycles of the lithium secondary batteries manufactured in Example 1, Example 2 and Comparative Example 1 (bare Li). When referring to FIG. 10, the fibrous filler was dense in Example 1 according to the present invention reducing lithium ion migration, and resistance slightly increased compared to the lithium metal of Comparative Example 1 (bare Li).

In Example 2, similar voltage and resistance properties were obtained as in Comparative Example 1, and this indicates that, when the particulate filler was inserted between the fibrous filler network structures, space between the network structures widened resulting in relatively smooth lithium ion transfer compared to Example 1.

(3) Charge and Discharge Evaluation

After charging and discharging the lithium secondary battery manufactured in Example 3 110 times with 0.1 C while operating the battery, a charge and discharge test was carried out for 900 hours by applying 1.0 C, and the results are shown in FIG. 11.

When referring to FIG. 11, it was seen that charge and discharge were progressed steadily for 900 hours without overvoltage occurrences. Particularly, such a trend was maintained even when increasing the rate from 0.1 C to 1.0 C after 550 hours. From this result, it can be seen that the passivation layer according to the present invention had an excellent ion transfer ability as well as a lithium dendrite suppression ability.

When used as a negative electrode of a lithium secondary battery, the lithium metal according to the present invention increases ion conductivity of lithium ions and suppresses lithium dendrite production and thereby enhances battery performance even at a high rate, and therefore, may be effectively utilized in various industrial fields using a lithium secondary battery such as portable electronic devices and electric vehicles.

### REFERENCE NUMERAL

10, 100: Lithium Electrode
1, 11: Lithium Metal Layer
3, 3A, 3B, 3C, 33: Passivation Layer
31, 31a, 31b, 31c: Fibrous Filler
33, 33a, 33b, 33c: Ion Conductive Polymer
35, 35a, 35b, 35c: Particulate Filler
55: Current Collector

1. A passivation layer for a lithium electrode having a fibrous network structure including a cellulose-based fibrous filler.

2. The passivation layer for a lithium electrode of claim 1, which has a thickness of 10 nm to 10 μm.

3. The passivation layer for a lithium electrode of claim 1, wherein the fibrous filler further includes any one or more of an organic filler and an inorganic filler.

4. The passivation layer for a lithium electrode of claim 3, wherein the organic filler includes one types selected from the group consisting of acryl-based fibers, amide-based fibers, olefin-based fibers, ester-based fibers, urethane-based fibers, styrene-based fibers, imide-based fibers and combinations thereof

5. The passivation layer for a lithium electrode of claim 3, wherein the inorganic filler includes one type selected from the group consisting of alumina fibers, aluminosilicate fibers, silica fibers, aluminosilicate, aluminoborosilicate, mullite, magnesium silicate fibers, calcium magnesium silicate fibers and combinations thereof.

6. The passivation layer for a lithium electrode of claim 1, wherein the fibrous filler has an average fiber diameter of 1 nm to 10 μm and an average fiber length of 100 nm to 500 μm.

7. The passivation layer for a lithium electrode of claim 1, further comprising one type selected from the group consisting of an ion conductive polymer, a lithium salt, a particulate filler and a mixture thereof.

8. The passivation layer for a lithium electrode of claim 7, wherein the ion conductive polymer forms a network structure in the passivation layer through crosslinking.

9. The passivation layer for a lithium electrode of claim 7, wherein the ion conductive polymer includes one type selected from the group consisting of polyethylene oxide, polypropylene oxide, polydimethylsiloxane, polyacrylonitrile, polymethyl (meth)acrylate, polyvinyl chloride, polyvinylidene fluoride, polyvinylidene fluoride-co-hexafluoropropylene, polyethyleneimine, polyphenylene terephthalamide, polymethoxypolyethylene glycol (meth)acrylate, poly-2-methoxyethyl glycidyl ether and combinations thereof.

10. The passivation layer for a lithium electrode of claim 7, wherein the ion conductive polymer is used in greater than 0 parts by weight and less than or equal to 5000 parts by weight with respect to 100 parts by weight of the fibrous filler.

11. The passivation layer for a lithium electrode of claim 7, wherein the lithium salt includes one type selected from the group consisting of LiCl, LiBr, LiI, LiClO₄, LiBF₄, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, (FSO₂)₂NLi, chloroborane lithium, lower aliphatic carboxylic acid lithium, lithium tetraphenylborate, lithium imide and combinations thereof

12. The passivation layer for a lithium electrode of claim 7, which uses, when using the ion conductive polymer and the lithium salt, the lithium salt in 1 parts by weight to 100 parts by weight with respect to 100 parts by weight of the ion conductive polymer.

13. The passivation layer for a lithium electrode of claim 7, wherein the particulate filler has an average particle diameter of 1 nm to 5 μm.

14. The passivation layer for a lithium electrode of claim 7, wherein the particulate filler includes one type selected from the group consisting of organic particles, inorganic particles and combinations thereof.

15. The passivation layer for a lithium electrode of claim 14, wherein the organic particles include one type selected from the group consisting of polyethylene, polypropylene, poly(meth)acrylate, polymethyl (meth)acrylate, polytetrafluoroethylene (PTFE), polyvinylidene fluoride (PVDF), perfluoroalkyl polymers (PFA), polyethylene terephthalate (PET), polybutylene terephthalate (PBT), polysiloxane, polysilazane, polycarbosilane and combinations thereof

16. The passivation layer for a lithium electrode of claim 14, wherein the inorganic particles include one type selected from the group consisting of alumina, silica, titania, zirconia, zinc oxide, antimony oxide, ceria, talc, forsterite, potassium carbonate, aluminum hydroxide, talcum, clay, talcum, barium sulfate, zeolite, kaolin, mica, montmorillonite, silicon nitride, boron nitride, barium titanate and combinations thereof.

17. The passivation layer for a lithium electrode of claim 7, wherein the particulate filler is used in greater than 0 parts by weight and less than or equal to 1000 parts by weight with respect to 100 parts by weight of the fibrous filler.

18. A lithium electrode comprising a passivation layer laminated on one side or both sides of a lithium metal layer,
wherein the passivation layer is the passivation layer of claim 1.

19. The lithium electrode of claim 18, wherein the lithium metal layer includes lithium metal; or an alloy of lithium metal and one type of metal selected from the group consisting of Si, Sn, C, Pt, Ir, Ni, Cu, Ti, Na, K, Rb, Cs, Fr, Be, Mg, Ca, Sr, Sb, Pb, In, Zn, Ba, Ra, Ge, Al and combinations thereof.

20. A lithium secondary battery comprising the lithium electrode of claim 18.
